(19) United States
(12) Patent Application Publication
(10) Pub. No.: US 2013/0124722 A1
(43) Pub. Date: May 16, 2013

(54) SYSTEM AND METHOD FOR ADJUSTING CENTRAL PROCESSING UNIT UTILIZATION RATIO

(71) Applicants: GUANG-JIAN WANG, Shenzhen City (CN); XIAO-MEI LIU, Shenzhen City (CN); DAI-GANG ZHANG, Shenzhen City (CN)

(72) Inventors: GUANG-JIAN WANG, Shenzhen City (CN); XIAO-MEI LIU, Shenzhen City (CN); DAI-GANG ZHANG, Shenzhen City (CN)

(21) Appl. No.: 13/661,332

(22) Filed: Oct. 26, 2012

(30) Foreign Application Priority Data
Nov. 16, 2011 (CN) 201110363717.9

(51) Int. Cl. G06F 15/16; G06F 9/455

(52) U.S. Cl. 709/224

(57) ABSTRACT

A method for adjusting a central processing unit (CPU) utilization ratio of a cloud server of a datacenter using a remote server. The remote server sets a CPU utilization ratio range for a host operating system (OS) installed in a cloud server. The remote server calculates a score after the guest OS is transferred into the host OS, and calculates the score for revising CPU utilization ratio range after the guest OS is transferred out of the host OS. The remote server revises the CPU utilization ratio range according to the score.

### BACKGROUND

1. Technical Field

Embodiments of the present disclosure relate to virtualization technology, and particularly to a central processing unit (CPU) utilization ratio adjustment system and method.

2. Description of Related Art

A CPU utilization ratio is a factor to show a performance of a computer. However, at present, the CPU utilization ratio falls within a fixed range when the computer works normally, for example, 30%-80% (e.g., a capacity usage of the CPU), which is not flexible. Thus the CPU may be under-utilized some of the time. Therefore, there is room for improvement in the art.

### BRIEF DESCRIPTION OF THE DRAWINGS

FIG. 1 is a system view of one embodiment of a CPU utilization ratio adjustment system.

FIG. 2 is a block diagram of one embodiment of a remote server included in FIG. 1.

FIG. 3 is a flowchart of one embodiment of a CPU utilization ratio adjustment method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

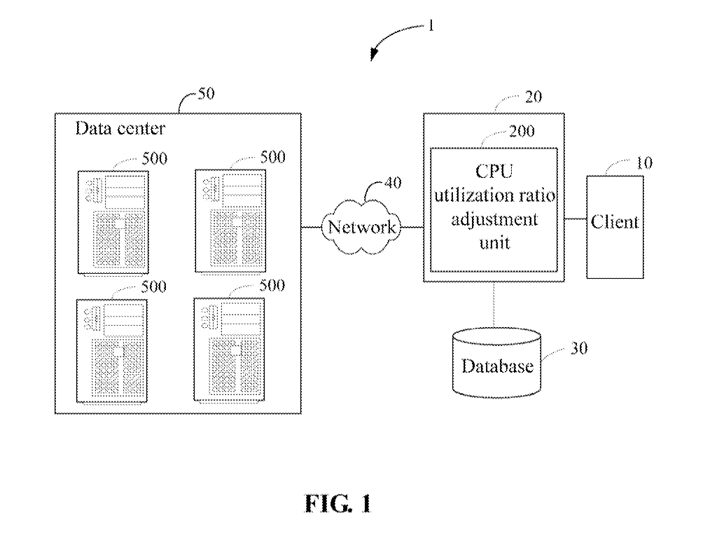

FIG. 1 is a system view of one embodiment of a CPU utilization ratio adjustment system 1. In one embodiment, the CPU utilization ratio adjustment system 1 may include a remote server 20 and a data center 50. The data center 50 is designed for cloud computing capability, and includes a plurality of cloud servers 500. The remote server 20 is connected to one or more client computers 10, and connected to the data center 50 via a network 40. The network 40 may be a wide area network (e.g., the Internet) or a local area network. The CPU utilization ratio adjustment system 1 may be used to monitor a CPU utilization ratio of each of the cloud servers 500. Using open database connectivity (ODBC) or java database connectivity (JDBC), for example, the remote server 20 is connected to a database system 30. The database system 30 may store the CPU utilization ratio, which is obtained by the remote server 20. Additionally, each of the one or more client computers 10 provides an operation interface for controlling one or more operations of the remote server 20.

The cloud servers 500 store the CPU utilization ratio. The CPU utilization ratio may show performance of the cloud servers 500 and be generated by the cloud servers 500 itself when the cloud servers 500 run. Additionally, the cloud servers 500 may store a serial number of each of the cloud servers 500, a voltage of each of the cloud servers 500, a rotational speed of a fan of each of the cloud servers 500, a temperature of each of the cloud servers 500, a status of each of the cloud servers 500 (e.g., power on/off), a memory utilization ratio of each of the cloud servers 500, a disk utilization ratio of each of the cloud servers 500, and a network traffic of each of the cloud servers 500.

Each of the cloud servers 500 is installed with a host operating system (OS). The host OS is installed with one or more guest OS. In order to manage the one or more guest OS, each of the cloud servers 500 is installed with a virtual machine management application (e.g., HYPERVISOR). The HYPERVISOR is used to manage and monitor execution of the one or more guest OS. The HYPERVISOR also obtains the CPU utilization ratio of each of the one or more guest OS from each of the cloud servers 500.

The remote server 20, in one example, can be also a dynamic host configuration protocol (DHCP) server. The remote server 20 is installed with a DHCP service. In one embodiment, the remote server 20 assigns Internet protocol (IP) addresses to the cloud servers 500 by the DHCP service. In one embodiment, the remote server 20 uses dynamic allocation to assign the IP addresses to the cloud servers 500. For example, when the remote server 20 receives a request from a cloud server 500 via the network 40, the remote server 20 dynamically assigns an IP address to the cloud server 500. In one embodiment, the remote server 20 may be a personal computer (PC), a network server, or any other data-processing equipment which can provide IP address allocation function.

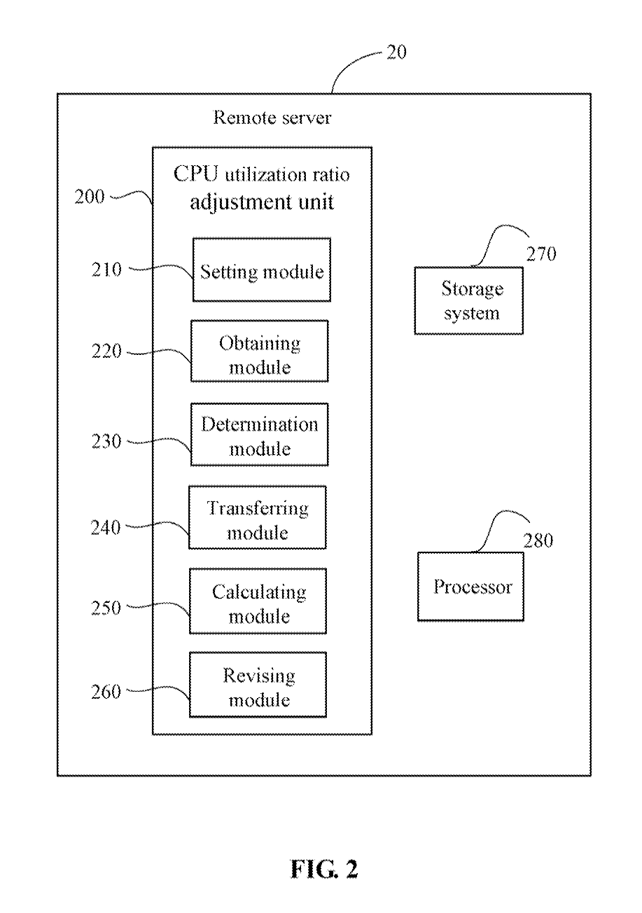

FIG. 2 is a block diagram of one embodiment of the remote server 20. The remote server 20 includes a CPU utilization ratio adjustment unit 200. The CPU utilization ratio adjustment unit 200 revises a CPU utilization ratio range of a host OS installed in the cloud server 500. The remote server 20 includes a storage system 270, and at least one processor 280. In one embodiment, the CPU utilization ratio adjustment unit 200 includes a setting module 210, an obtaining module 220, a determination module 230, a transferring module 240, a calculating module 250, and a revising module 260. The modules 210-260 may include computerized code in the form of one or more programs that are stored in the storage system 270. The computerized code includes instructions that are executed by the at least one processor 280 to provide functions for the modules 210-260. The storage system 270 may be a memory device, such as an erasable programmable read only memory (EPROM), hard disk drive (HDD), or flash memory.

The setting module 210 sets a CPU utilization ratio range (hereinafter, “the range”) for a host OS installed in the cloud server 500. For example, the CPU utilization ratio range may be set as 30%-80% (e.g., a percentage capacity usage of a CPU).

The obtaining module 220 obtains a CPU utilization ratio of the host OS from the cloud server 500. In one embodiment, the obtaining module 220 obtains the CPU utilization ratio of the host OS from the HYPERVISOR installed in the cloud server 500.

The determination module 230 determines if the obtained CPU utilization ratio falls outside the range. In one embodiment, if the obtained CPU utilization ratio is less than a lower limit of the range or is greater than an upper limit of the range, the obtained CPU utilization ratio is determined as falling outside the range. For example, if the range is set as 30%-80%, 30% is the lower limit of the range, and 80% is the upper limit of the range.

The transferring module 240 transfers a guest OS from another cloud server 500 into the host OS of the cloud server 500 if the obtained CPU utilization ratio is less than a lower limit of the range, and transfers the guest OS out of the host OS of the cloud server 500 to the another cloud server 500 if the obtained CPU utilization ratio is greater than a lower limit of the range.

The determination module 230 determines if the obtained CPU utilization ratio falls within the range after the guest OS is transferred into the host OS, and determines if the obtained CPU utilization ratio falls within the range after the guest OS is transferred out of the host OS.

The calculating module 250 calculates a score for revising the range. The score is a percentage value (e.g., 2%), and used to revise the range. An initial value of the score may be, but is not limited to, 0%. In one embodiment, if the obtained CPU utilization ratio falls within the range after the guest OS is transferred into the host OS, the score is plus 2%. If the obtained CPU utilization ratio is less than the lower limit of the range after the guest OS is transferred into the host OS, the score is minus 20%. If the obtained CPU utilization ratio is greater than the upper limit of the range after the guest OS is transferred into the host OS, the score is minus 10%. If the obtained CPU utilization ratio falls within the range after the guest OS is transferred out of the host OS, the score is plus 2%. If the obtained CPU utilization ratio is greater than the upper limit of the range after the guest OS is transferred out of the host OS, the score is minus 20%. If the obtained CPU utilization ratio is less than the lower limit of the range after the guest OS is transferred out of the host OS, the score is minus 10%.

The revising module 260 revises the range according to the score. The revising module 260 revises the range by amending the lower limit of the range or the upper limit of the range using the score. In one embodiment, the revising module 260 adds the plus score to the lower limit of the range, if the obtained CPU utilization ratio falls within the range after the guest OS is transferred into the host OS. The revising module 260 adds the plus score to the upper limit of the range, if the obtained CPU utilization ratio falls within the range after the guest OS is transferred out of the host OS. The revising module 260 adds the minus score to the lower limit of the range, if the obtained CPU utilization ratio is less than a lower limit of the range after the guest OS is transferred into the host OS. The revising module 260 adds the minus score to the upper limit of the range, if the obtained CPU utilization ratio is greater than the upper limit of the range after the guest OS is transferred into the host OS. The revising module 260 adds the minus score to the upper limit of the range, if the obtained CPU utilization ratio is greater than the upper limit of the range after the guest OS is transferred out of the host OS. The revising module 260 adds the minus score to the lower limit of the range, if the obtained CPU utilization ratio is less than the lower limit of the range after the guest OS is transferred out of the host OS.

The determination module 230 further determines if a number of consecutive revised ranges oscillate back and forth. The number of the consecutive revised ranges is determined to oscillate back and forth based on the lower (e.g., 30%) or the upper limit (e.g., 80%) of the range. In one embodiment, the number of consecutive revised ranges may be at least five times. For example, the ranges are revised five times. The range is first revised to 30%-82%, secondly revised to 30%-77%, thirdly revised to 30%-83%, fourthly revised to 30%-76%, and fifthly revised to 30%-85%, then the five consecutive revised ranges are determined to oscillate back and forth based on the upper limit (e.g., 80%) of the range. The revised range 30%-85% is regarded as the CPU utilization ratio range of the cloud server 500 and saved into the cloud server 500.

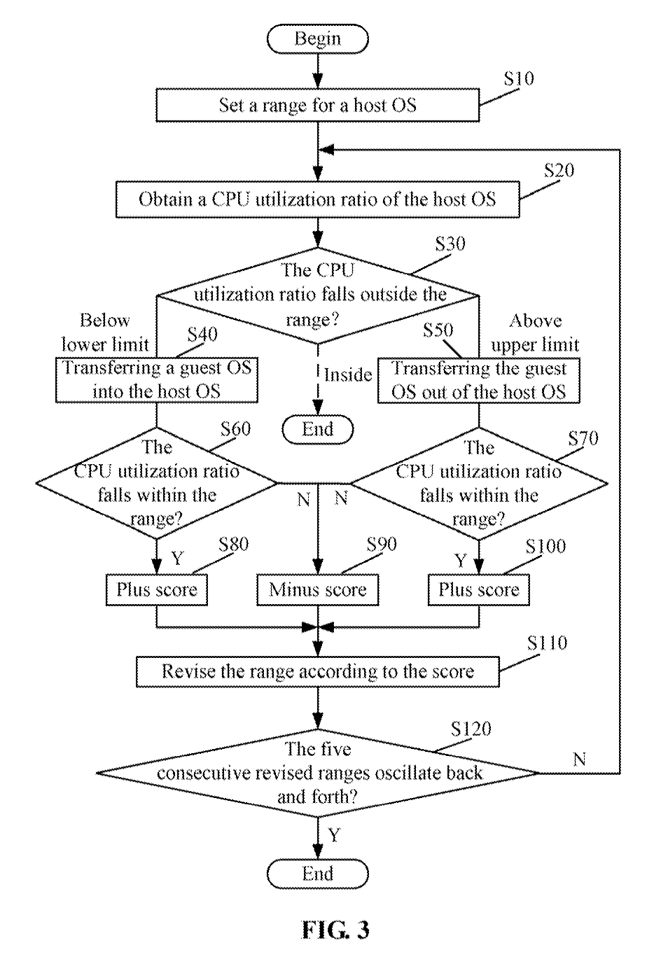

FIG. 3 is a flowchart of one embodiment of a CPU utilization ratio adjustment method. Depending on the embodiment, additional steps may be added, others deleted, and the ordering of the steps may be changed.

In step S10, the setting module 210 sets a range for the host OS installed in the cloud server 500. For example, the range may be set as 30%-80% (e.g., a percentage capacity usage of the CPU).

In step S20, the obtaining module 220 obtains a CPU utilization ratio of the host OS from the cloud server 500. In one embodiment, the HYPERVISOR installed in the cloud server 500 obtains the CPU utilization ratio of the host OS from the cloud server 500 and sends the obtained CPU utilization ratio of the host OS to the obtaining module 220.

In step S30, the determination module 230 determines if the obtained CPU utilization ratio falls outside the range. In one embodiment, if the obtained CPU utilization ratio is less than 20%, the procedure goes to step S40. Otherwise, if the obtained CPU utilization ratio is greater than 80%, the procedure goes to step S50. In additions, if the obtained CPU utilization ratio falls inside the range, the procedure ends.

In step S40, the transferring module 240 transfers the guest OS from another cloud server 500 into the host OS of the cloud server 500. For example, if the CPU utilization rate of the host OS of the cloud server A is 18%, the transferring module 250 invokes HYPERVISOR to transfer the guest OS from another cloud server 500 (e.g., the cloud server B) to the cloud server A.

In step S50, the transferring module 240 transfers the guest OS out of the host OS of the cloud server 500 to the another cloud server 500. For example, if the CPU utilization rate of the host OS of the cloud server A is 88%, the transferring module 250 invokes HYPERVISOR to transfer the guest OS from the cloud server A to the another cloud servers 500 (e.g., the cloud server B).

In step S60, the determination module 230 determines if the obtained CPU utilization ratio falls within the range after the guest OS is transferred into the host OS. In one embodiment, if the obtained CPU utilization ratio falls within the range after the guest OS is transferred into the host OS, the procedure goes to step S80. Otherwise, the obtained CPU utilization ratio does not fall within the range after the guest OS is transferred into the host OS, the procedure goes to step S90.

In step S70, the determination module 230 determines if the obtained CPU utilization ratio falls within the range after the guest OS is transferred out of the host OS. In one embodiment, if the obtained CPU utilization ratio falls within the range after the guest OS is transferred out of the host OS, the procedure goes to step 5100. Otherwise, if the obtained CPU utilization ratio does not fall within the range after the guest OS is transferred out of the host OS, the procedure goes to step S90.

In step S80, the calculating module 250 obtains a plus score. In one embodiment, if the obtained CPU utilization ratio falls within the range after the guest OS is transferred into the host OS, the score is plus 2%.

In step S90, the calculating module 250 obtains minus score. If the obtained CPU utilization ratio is less than a lower limit of the range after the guest OS is transferred into the host OS, the score is minus 20%. If the obtained CPU utilization ratio is greater than the upper limit of the range after the guest OS is transferred into the host OS, the score is minus 10%. If the obtained CPU utilization ratio is greater than the upper limit of the range after the guest OS is transferred out of the host OS, the score is minus 20%. If the obtained CPU utilization ratio is less than the lower limit of the range after the guest OS is transferred out of the host OS, the score is minus 10%.

In step S100, the calculating module 250 obtains the plus score for revising the range. In one embodiment, if the obtained CPU utilization ratio falls within the range after the guest OS is transferred out of the host OS, the score is plus 2%.

In step S110, the revising module 260 revises the range according to the score. In one embodiment, assuming that the range is 30%-80%, if the obtained CPU utilization ratio falls within the range after the guest OS is transferred into the host OS, the score is plus 2%, the range is revised to 28%-80%. If the obtained CPU utilization ratio falls within the range after the guest OS is transferred out of the host OS, the score is plus 2%, the range is revised to 30%-82%. If the obtained CPU utilization ratio is less than a lower limit of the range after the guest OS is transferred into the host OS, the score is minus 20%, the range is revised to 10%-80%. If the obtained CPU utilization ratio is greater than the upper limit of the range after the guest OS is transferred into the host OS, the score is minus 10%, the range is revised to 30%-60%. If the obtained CPU utilization ratio is greater than the upper limit of the range after the guest OS is transferred out of the host OS, the score is minus 20%, the range is revised to 30%-60%. If the obtained CPU utilization ratio is less than the lower limit of the range after the guest OS is transferred out of the host OS, the score is minus 10%, the range is revised to 10%-80%.

In step S120, the determination module 230 further determines if a number of consecutive revised ranges oscillate back and forth. In one embodiment, if the five consecutive revised ranges oscillate back and forth, the procedure ends. Otherwise, if the five consecutive revised ranges oscillate back and forth, the procedure returns to S20.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote server, the remote server in electronic communication with a cloud server of a data center, the remote server comprising:
a storage system;
at least one processor; and
one or more programs stored in the storage system and being executable by the at least one processor, the one or more programs comprising:
a setting module sets a central processing unit (CPU) utilization range for a host operating system (OS) installed in the cloud server;
an obtaining module obtains a CPU utilization ratio of the host OS from the cloud server;
a transferring module transfers a guest OS from another cloud server of the data center into the host OS if the obtained CPU utilization ratio is less than a lower limit of the CPU utilization ratio range;
the transferring module further transfers the guest OS out of the host OS to the another cloud server if the obtained CPU utilization ratio is greater than an upper limit of the CPU utilization ratio range;
a calculating module calculates a score for revising the CPU utilization ratio range after the guest OS is transferred into the host OS, or calculates the score after the guest OS is transferred out of the host OS; and
a revising module revises the CPU utilization ratio range according to the score.

2. The remote server of claim 1, wherein the determination module further determines if a number of consecutive revised CPU utilization ratio ranges oscillate back and forth based on the lower or the upper limit of the CPU utilization ratio range.

3. The remote server of claim 1, wherein the score is a percentage value.

4. The remote server of claim 1, wherein the revising module revises the CPU utilization ratio range by amending the lower limit of the CPU utilization ratio range or the upper limit of the CPU utilization ratio range using the score.

5. The remote server of claim 1, wherein the obtaining module obtains the CPU utilization ratio of the host OS from a virtual machine management application installed in the cloud server.

6. The remote server of claim 1, wherein the transferring module transfers the guest OS using the virtual machine management application.

7. A computer-based CPU utilization ratio adjustment method being performed by execution of computer readable program code by a processor of a remote server, the remote server in electronic communication with a cloud server of a data center, the method comprising:
setting a central processing unit (CPU) utilization ratio range for a host operating system (OS) installed in the cloud server;
obtaining a CPU utilization ratio of the host OS from the cloud server;
transferring a guest OS from another cloud server of the data center into the host OS if the obtained CPU utilization ratio is less than a lower limit of the CPU utilization ratio range;
transferring the guest OS out of the host OS to the another cloud server if the obtained CPU utilization ratio is greater than an upper limit of the CPU utilization ratio range;
calculating a score for revising the CPU utilization ratio range after the guest OS is transferred into the host OS;
calculating the score after the guest OS is transferred out of the host OS; and
revising the CPU utilization ratio range according to the score.

8. The method of claim 7, further comprising:
determining if a number of consecutive revised CPU utilization ratio ranges oscillate back and forth based on the lower or the upper limit of the CPU utilization ratio range.

9. The method of claim 7, wherein the score is a percentage value.

10. The method of claim 7, wherein the range is revised by amending the lower limit of the CPU utilization ratio range or the upper limit of the CPU utilization ratio range using the score.

11. The method of claim 7, wherein the CPU utilization ratio of the host OS is obtained from a virtual machine management application installed in the cloud server.

12. The method of claim 7, wherein the guest OS is transferred using the virtual machine management application.

13. A non-transitory computer-readable medium having stored thereon instructions that, when executed by a remote server, the remote server in electronic communication with a cloud server of a data center, causing the remote server to perform a CPU utilization ratio adjustment method, the method comprising:
setting a central processing unit (CPU) utilization ratio range for a host operating system (OS) installed in the cloud server;
obtaining a CPU utilization ratio of the host OS from the cloud server;
transferring a guest OS from another cloud server of the data center into the host OS if the obtained CPU utilization ratio is less than a lower limit of the CPU utilization ratio range;
transferring the guest OS out of the host OS to the another cloud server if the obtained CPU utilization ratio is greater than an upper limit of the CPU utilization ratio range;
calculating a score for revising the CPU utilization ratio range after the guest OS is transferred into the host OS;
calculating the score after the guest OS is transferred out of the host OS; and
revising the CPU utilization ratio range according to the score.

14. The non-transitory medium of claim 13, wherein the method comprises:
determining if a number of consecutive revised CPU utilization ratio ranges oscillate back and forth based on the lower or the upper limit of the CPU utilization ratio range.

15. The non-transitory medium of claim 13, wherein the score is a percentage value.

16. The non-transitory medium of claim 13, wherein the range is revised by amending the lower limit of the CPU utilization ratio range or the upper limit of the CPU utilization ratio range using the score.

17. The non-transitory medium of claim 13, wherein the CPU utilization ratio of the host OS is obtained from a virtual machine management application installed in the cloud server.

18. The non-transitory medium of claim 13, wherein the guest OS is transferred using the virtual machine management application.
